(19) United States
(12) Patent Application Publication
(10) Pub. No.: US 2020/0226159 A1
(43) Pub. Date: Jul. 16, 2020

(54) SYSTEM AND METHOD OF GENERATING READING LISTS

(71) Applicant: FUJITSU LIMITED, Kawasaki-shi (JP)

(72) Inventors: Jun WANG, San Jose, CA (US); Kanji UCHINO, Santa Clara, CA (US)

(73) Assignee: FUJITSU LIMITED, Kawasaki-shi (JP)

(21) Appl. No.: 16/245,141

(22) Filed: Jan. 10, 2019

(51) Int. Cl. G06F 16/335; G06F 16/953; G06F 16/35; G06N 20/00

(52) U.S. Cl. CPC G06F 16/335; G06N 20/00; G06F 16/35; G06F 16/953

(57) ABSTRACT

An example computer-implemented method may include generating a corpus of content, where the corpus of content comprises content items. The method may also include calculating a ranking score of each content item in the corpus of content items, where the ranking score of a content item is based on one or more of a topic match of the content item, a credit of the content item, and a freshness of the content item. The method may further include aggregating each content item of the content items into one of multiple sections in a reading list tailored for a user, and ranking the content items in each section based on respective ranking scores of the content items. The reading list may then be displayed, for example, for viewing by the user.

### FIELD

This disclosure relates generally to generating reading lists.

### BACKGROUND

There is an overwhelming amount of information that is readily available and accessible partly due to the ability of individuals to disseminate information freely, quickly, and easily. The result is that more and more content is available to more and more people. Although the Internet is a vast trove of information, the information may be scattered online among various websites and platforms. For example, leading researchers may be sharing content and exchanging ideas using a variety of different platforms including social media and domain-specific publication websites. This results in users being faced with the daunting task of searching, aggregating, collecting, and organizing information of interest to the users.

More information, such as scientific and technical literature, is becoming instantly accessible than ever before. For example, digest reading lists (“newsletters”) are getting more and more popular, such as “the wild week in AI,” “NLP news,” “Data science weekly,” “python weekly,” “Frontend focus.” The vast amounts of information mean that it is also harder for users to determine what information is relevant to them, and for the users to readily consume this information. In many instances, users use standard information retrieval tools, such as a search engine, to find information on the World Wide Web (the Web). In the case of search engines, a user provides a search query (e.g., a few key words), and the search engine finds and returns a list of contents (e.g., webpages, documents, etc.) found on the Web ranked according to relevance to the provided search query. However, how a search engine decides which items of content are the best matches to the search query, and the order in which the search results are shown, varies widely from one search engine to another. As a result, users are still left with the task of determining what items of content in the list may be relevant to a given topic of interest.

Services that provide periodic reading lists are available that help users access and consume the vast amounts of information. For example, a service may search the Web for content (information) on a particular topic, and provide a list of the identified items of content to the users in a reading list. Some services may also provide a short digest of the information included in each item of content in the reading list to assist the users in identifying the items of content that may be of interest to the users. Unfortunately, the reading lists provided by such services are typically homogeneous to a single topic and/or type of information source. Also, the reading lists are typically not well organized in that the lists include items of content of varying types that are not organized into logical types and/or sections. Moreover, these reading lists are general in that they are targeted to and/or for consumption by “generic” users, rather than being tailored for a specific user. Furthermore, some of these services rely on a human domain expert to manually edit or curate the reading lists.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

According to some examples, computer-implemented methods to generate a reading list are described. An example computer-implemented method may include generating a corpus of content, where the corpus of content comprises content items. The method may also include calculating a ranking score of each content item in the corpus of content items, where the ranking score of a content item is based on one or more of a topic match of the content item, a credit of the content item, and a freshness of the content item. The method may further include aggregating each content item of the content items into one of multiple sections in a reading list tailored for a user, and ranking the content items in each section based on respective ranking scores of the content items. The reading list may then be displayed, for example, for viewing by the user.

The objects and advantages of the embodiments will be realized and achieved at least by the elements, features, and combinations particularly pointed out in the claims.

Both the foregoing general description and the following detailed description are given as examples, are explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 is a block diagram of an example environment in which a reading list system may be implemented;

FIG. 2 is a block diagram illustrating selected components of the reading list system of FIG. 1;

FIG. 3 is a flow diagram illustrating an example high-level process to generate a reading list;

FIG. 4 is a flow diagram illustrating an example process to perform topic analysis;

FIG. 5 is a flow diagram illustrating an example process to perform genre analysis;

FIG. 6 is a flow diagram illustrating an example process to generate a reading list tailored for a user;

FIG. 7 is a flow diagram illustrating an example process to determine a user profile;

FIG. 8 is a flow diagram illustrating an example process to calculate general ranking scores;

FIG. 9 is a flow diagram illustrating an example process to aggregate a reading list;

FIG. 10 is a flow diagram illustrating an example process to filter content items to include in a reading list;

FIG. 11 is a flow diagram illustrating an example process to enhance diversity in a reading list; and

FIG. 12 is a block diagram illustrating selected components of an example computing system that may be used to perform any of the techniques as variously described in the present disclosure,

all in accordance with at least some embodiments of the present disclosure.

### DESCRIPTION OF EMBODIMENTS

Techniques are disclosed for generating an organized reading list of heterogeneous items of content from various information sources. In accordance with some embodiments of the present disclosure, a reading list system may crawl information sources and fetch information to generate a corpus of content. For example, the information sources may be web sites on the Web. The reading list system may process the corpus of content to identify items of content (also referred to herein as “content items”) that are determined to be appropriate to be included in a reading list, and generate a reading list that lists the identified items of content. The reading list may list the items of content of different genres, such as news, articles, publications, and programming codes (e.g., software), to name a few examples, in well-organized sections. In some embodiments, the reading list may be personalized for consumption by a specific user and, in some embodiments, personalized to an expertise level of the user. Additionally or alternatively, the reading list may be tailored for a specific domain or domains of knowledges. In these and other embodiments, the reading list may include a digest of the information contained in each item of content listed in the reading list. In any such cases, the reading list system may identify items of content that is relevant to a specific user from various information sources, and list the identified items of content in a reading list in a manner that is easy for the user to discern and consume.

The disclosed techniques significantly improve the efficiency (e.g., reduce computational resources, increase speed, and the like) computer-based systems (e.g., web browsers) in identifying and compiling items of content by of generating a reading list that lists heterogeneous items of content in a manner that is appropriate for a specific user. For example, the items of content in the reading list may be listed in well-organized sections and in an order that is relevant for consumption by the intended user of the reading list. Additionally, various embodiments described in the present disclosure employ machine learning to efficiently process the vast amounts of information retrieved from the Web to identify the items of content for inclusion in the reading list. Utilization of such machine learning technologies significantly increases the amount of information considered for inclusion in the reading list, which improves the quality of the information provided in the reading list by the computer-based systems. These and other advantages and alternative embodiments will be apparent in light of this disclosure.

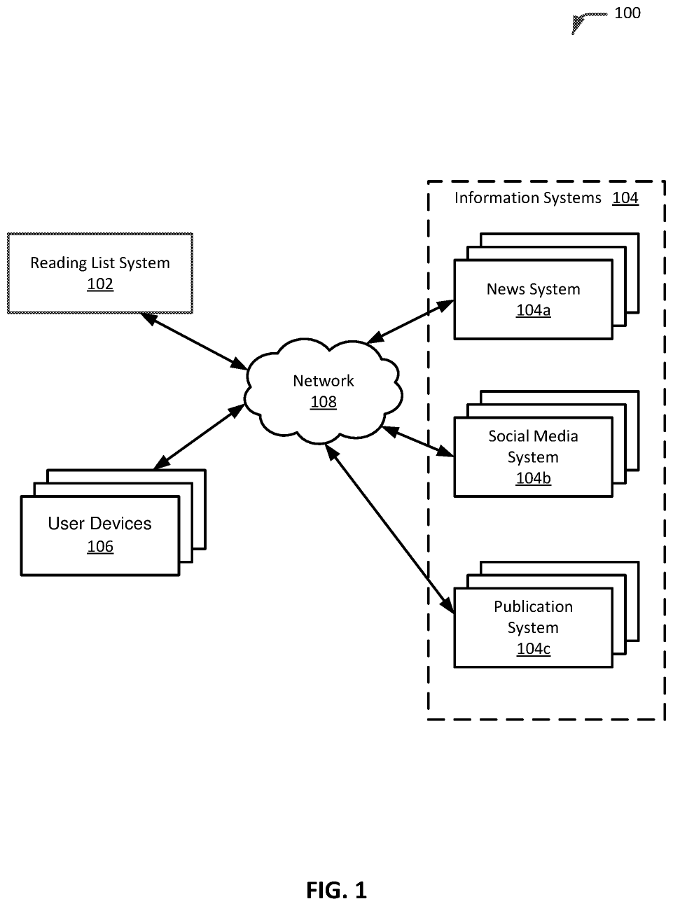

FIG. 1 is a block diagram of an example environment 100 in which a reading list system may be implemented, in accordance with at least some embodiments of the present disclosure. As depicted, environment 100 may include a reading list system (hereinafter “system”) 102, one or more information systems 104, and one or more user devices 106, each communicatively coupled to a network 108. In general, network 108 can be a local area network (LAN), a wide area network (WAN), the Internet, and/or other wired or wireless networks.

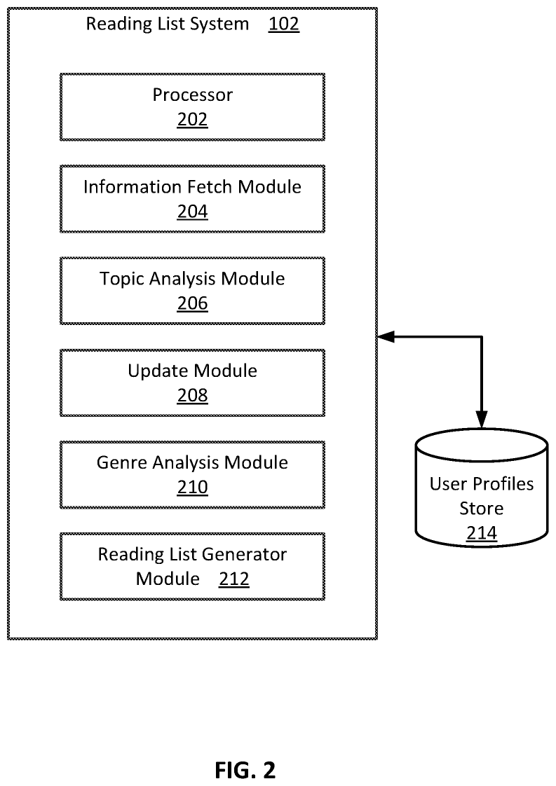

System 102 may be configured to provide a well-organized reading list that includes heterogeneous information from various sources and/or of various genres. In some embodiments, the generated reading list is of domain-specific content that may be from one or more information sources and which may be well-organized into one or more sections, where each section is of a specific genre. System 102 may generate a reading list that is tailored for a specific user in accordance with information contained in a user profile associated with the user. System 102 will be further described below in conjunction with FIGS. 2-12.

Information systems 104 may provide the information that is locatable and/or available for inclusion in the reading lists, for example, generated by system 102. In one broad sense, information systems 104 include the systems on the Internet that comprise the Web. For instance, information systems 104 may be hosted by one or more corresponding web servers communicatively coupled to the Internet and include distributed online resources such as newspapers, journals, magazines, webpages, forums, blogs, and other online materials and/or information. Accordingly, information systems 104 may include websites of individuals, corporations, including television and media companies, institutions, including high schools, colleges, universities, other educational institutions, governments, or the like or any combination thereof. A website may be dedicated to a specific topic or purpose, such as social networking, entertainment, news, and education, to name a few examples. As illustrated in FIG. 1, information systems 104 include one or more news systems 104a, one or more social media systems 104b, and one or more publication systems 104c. For instance, news systems 104a may include news websites that provide news information (news content), and may include sites such as wired.com, zdnet.com, cnet.com, techcrunch.com, venturebeat.com, and bbc.com to name a few examples. Social media systems 104b may include social media websites that promote the sharing of information, ideas, interests, and other forms of expression, and may include sites such as Twitter and Facebook to name two examples. Publication systems 104c may include academic publication databases, scientific compilation databases, and/or other publication libraries or repositories, and may include sites such as Digital Bibliography & Library Project (DBLP), Association for Computing Machinery (ACM) Digital Library, Institute of Electrical and Electronics Engineers (IEEE) Xplore Digital Library, and Arxiv to name a few examples. As will be appreciated in light of this disclosure, information sources 104 may include other sources of information in addition to and/or in lieu of any one or more of the systems illustrated in FIG. 1.

User devices 106 include people and/or other entities that desire to interact with system 102 for certain of the services provided by system 102, such as access to reading lists as variously described herein. Although not separately illustrated, each of user device s 106 typically interacts with system 102 over network 108 using a suitable computing device, such as a desktop computer, a laptop computer, a tablet computer, a mobile phone, a smartphone, a personal digital assistant (PDA), or other suitable computing device.

FIG. 2 is a block diagram illustrating selected components of system 102 of FIG. 1, in accordance with at least some embodiments of the present disclosure. As illustrated, system 102 includes a processor 202, an information fetch module 204, a topic analysis module 206, an update module 208, a genre analysis module 210, and a reading list generator module 212. System 102 is configured to execute information fetch module 204, topic analysis module 206, update module 208, genre analysis module 210, reading list generator module 212, or any combination of these. System 102 is further configured to access (e.g., read and/or write, etc.) information representing user profiles from a user profiles store 214, which may include a database or other suitable data storage device. In some embodiments, user profiles store 214 can be implemented on a back-end server that is remote from system 102 and operable to communicate with system 102 over a network, such as the Internet or an intranet. User profiles store 214 may include any suitable digital storage device configured to store digitally encoded data.

In various embodiments, additional components (not illustrated, such as a user interface, non-transitory memory, etc.) or a subset of the illustrated components can be employed without deviating from the scope of the present disclosure. For instance, other embodiments may integrate the various functionalities of information fetch module 204, topic analysis module 206, update module 208, genre analysis module 210, and reading list generator module 212 into fewer modules (e.g., two, three, or four) or additional modules (e.g., six or seven, or more). In addition, further note that the various components of system 102 may all be in a stand-alone computing system according to some embodiments, while in others, may be distributed across multiple machines. For example, according to an embodiment, various functionalities of information fetch module 204, topic analysis module 206, update module 208, genre analysis module 210, and reading list generator module 212 may be provided in a computing system distinct from system 102. In a more general sense, the degree of integration and distribution of the functional component(s) provided herein can vary greatly from one embodiment to the next, as will be appreciated in light of this disclosure. In addition, the different modules may be implemented as software that includes code and routines configured to enable a computing device to perform one or more of the operations described with respect to the corresponding modules. Additionally or alternatively, the modules may be implemented using hardware including a processor, a microprocessor (e.g., to perform or control performance of one or more operations), a field-programmable gate array (FPGA), or an application-specific integrated circuit (ASIC). In some other instances, the modules may be implemented using a combination of hardware and software. In the present disclosure, operations described as being performed by a particular module may include operations that the particular module may direct a corresponding system to perform.

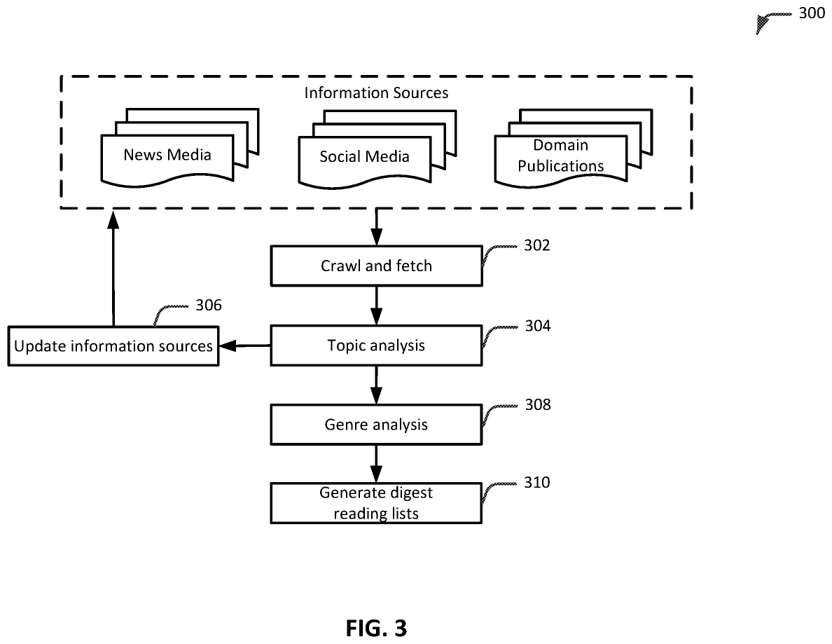

As will be described in further detail below, system 102 is configured to generate and provide users well-organized reading lists tailored to each specific user or a group of users. Briefly, in overview, information fetch module 204 is configured to retrieve content from various information sources and generate a corpus of content. Topic analysis module 208 is configured to process the corpus of content and determine the topics included or covered in the items of content. Update module 208 is configured to update the list of information sources from which system 102 obtains content, for example, based on the quality of content retrieved from the information sources. In this manner, the information sources may be updated to include sources that are determined to provide good content. Genre analysis module 210 is configured to extract information from an item of content based on a genre of the item of content, and use the extracted information to determine the quality of the item of content (e.g., the quality of the information contained in the item of content). Reading list generator module 212 is configured to aggregate a reading list that is tailored for a specific user. In various embodiment, reading list generator module 212 may aggregate a reading list based on the preferences of the user (e.g., as specified by information in a user profile of the user), the respective topics determined to be covered or otherwise included in the items of content, and/or the respective quality of the items of content. Various embodiments of information fetch module 204, topic analysis module 206, update module 208, genre analysis module 210, and reading list generator module 212 are further described below with reference to FIGS. 3-12.

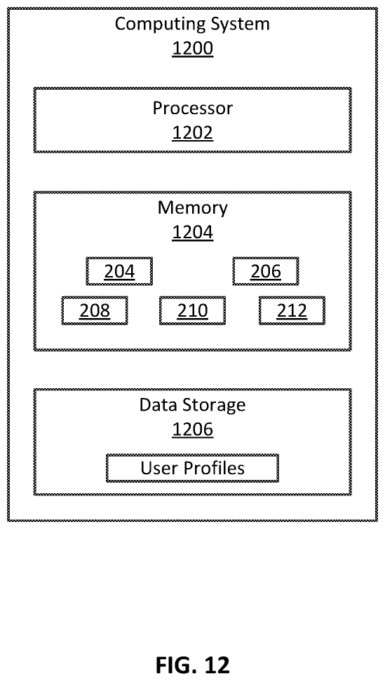

The operations, functions, or actions described in the respective blocks of example process 300, 400, 500, 600, 700, 800, 900, 1000, and 1100, which will be further discussed below with respect to FIGS. 3-11, may also be stored as computer-executable instructions in a computer-readable medium, such as a memory 1204 and/or a data storage 1206 of a computing system 1200, which will be further discussed below with respect to FIG. 12.

As will be further appreciated in light of this disclosure, for these and other processes and methods disclosed herein, the functions performed in the processes and methods may be implemented in differing order. Additionally or alternatively, two or more operations may be performed at the same time or otherwise in an overlapping contemporaneous fashion. Furthermore, the outlined actions and operations are only provided as examples, and some of the actions and operations may be optional, combined into fewer actions and operations, or expanded into additional actions and operations without detracting from the essence of the disclosed embodiments.

With reference to process 300 of FIG. 3, at block 302, information fetch module 204 crawls and fetches content items to be processed for inclusion in a reading list. Additionally or alternatively, information fetch module 204 may receive some content items. In an example implementation, information fetch module 204 may perform operations performed by a web crawler, a web spider, an ant, an automatic indexer, a web scutter, or any other suitable bot. Information fetch module 204 may obtain content items (e.g., webpages, blogs, or other content) from some or all of the information sources. As described previously, the information sources may include websites that provide various content. The obtained content items comprise the corpus of content that may be processed to identify content items to include in a reading list. Note that the corpus of content may include hundreds, thousands, tens of thousands, hundreds of thousands, or indeed, even a larger number of content items obtained from the information sources. In some embodiments, the information sources (websites) from which to obtain the content may be hard-coded, user specified, such as by a system administrator or other authorized user of system 102, or some combination thereof. In some embodiments, the information sources may be tunable in that the information sources may be updated to include websites previously not included in the information sources. For instance, if a website A that is not a current information source is determined to provide useful or otherwise good content, website A may be included in or otherwise identified as an information source such that information fetch module 204 crawls and fetches content from web site A.

At block 304, topic analysis module 206 processes the content items in the corpus of content and determines the topics included or covered in each content item. Note that a content item inherently includes key terms or phrases (e.g., a set of words) that represent knowledge points, which are the concepts, notions, ideas, etc., discussed or otherwise presented or covered in the content item. Accordingly, a knowledge point may include, for instance, the topics, the subtopics, and such key terms or phrases of the content item. For example, for the concept Graphical Model, the knowledge points may include graphical models, topic models, probabilistic model, generative model, latent variable, model selection, Hidden Markov Models, linear models, and variants thereof, to name a few examples. For the concept Neural Activity, the knowledge points may include receptive fields, spiking neurons, spike trains, firing rates, neural population, visual cortex, and variants thereof, to name a few examples. Topic analysis module 206 may extract such knowledge points from the content items in the corpus of content. The knowledge points extracted from the corpus of content may be considered a dictionary of knowledge points or key terms. Topic analysis module 206 may then determine the various knowledge point distributions (e.g., probability distributions of the knowledge points) in the corpus of content. As previously explained, knowledge points are the concepts, notions, ideas, etc., discussed or otherwise presented or covered in the content items from which the knowledge points are extracted. Accordingly, the probability distributions of the knowledge points correspond to the topics covered in the corpus of content. As such, each topic corresponds to a probability distribution of the knowledge points. Topic analysis module 206 may also determine a distribution of the topics in a content item based on the knowledge points contained in the content item.

In some embodiments, topic analysis module 206 builds a machine learning model by training a machine learning algorithm, such as a Bayesian inference algorithm, naive Bayes algorithm, or other suitable machine learning algorithm, using the extracted knowledge points. For instance, a suitable machine learning algorithm may be trained, for example, using unsupervised machine learning, to recognize the different probability distributions of the knowledge points. Topic analysis module 206 may then apply the model to the corpus of content to determine the topics covered in the corpus of content, where each topic is a probability distribution of the knowledge points. For example, suppose that the corpus of content includes 1,000,000 content items, which further include 10,000 knowledge points (key terms). The 10,000 knowledge points included in the corpus of content may be considered a dictionary of knowledge points. In this case, a machine learning algorithm may be trained to recognize the different probability distributions of the 10,000 knowledge points. When applied to the 1,000,000 content items, the machine learning model may determine that 100 topics (e.g., 100 different probability distributions of the 10,000 knowledge points) are in the 1,000,000 content items. The trained classifier may also generate a respective topic distribution (e.g., a distribution of the 100 topics) for the content items in the input corpus of content. Topic analysis module 206 may determine the topics included or covered in a content item from the generated topic distribution.

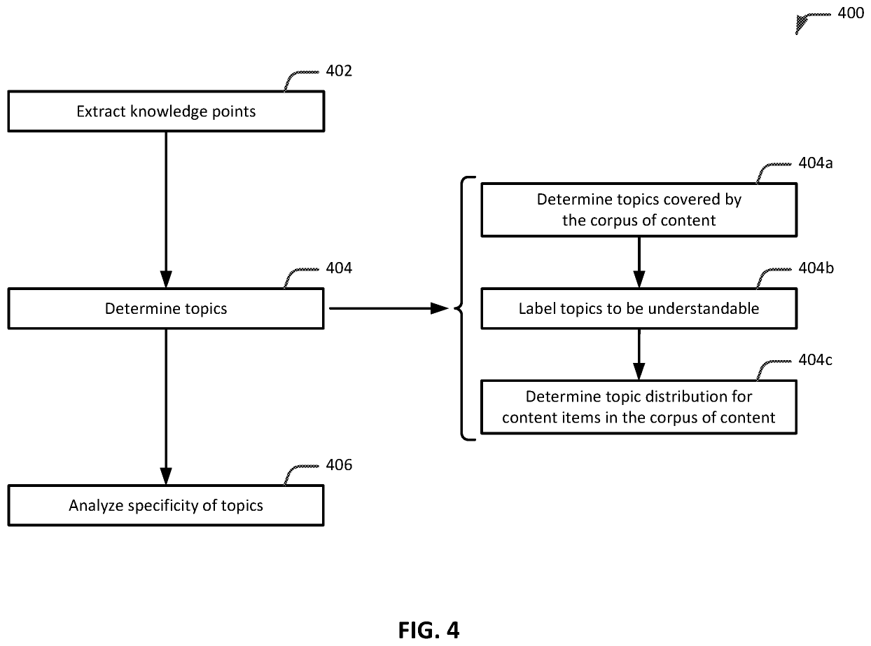

In some embodiments, process 400 illustrated in FIG. 4 may correspond to block 304 of process 300. With reference to process 400, at block 402, topic analysis module 206 extracts knowledge points from the content items in the corpus of content. As described previously and in a general sense, the knowledge points may refer to the concepts of the content items. At block 404, topic analysis module 206 determines the topics in the corpus of content and covered in each content item. As illustrated by process 400, block 404 may include blocks 404a-404c.

At block 404a, topic analysis module 206 determines the topics covered in the content items in the corpus of content. For instance, the covered topics may be determined using the extracted knowledge points. As described previously, topic analysis module 206 may utilize a machine learning model to determine the topics, according to some embodiments.

At block 404b, topic analysis module 206 labels the topics to be understandable, for example, by humans. As described previously, a topic is a probability distribution over the knowledge points. A probability distribution over the knowledge points may not be readily understandable. That is, a human may not readily understand what topic is represented or defined by a specific probability distribution over the knowledge points. As such, topic analysis module 206 may assign a descriptive label (e.g., machine learning, Bayesian Inference, graphical model, neural activity, World Cup, French Open, etc.) to each topic, where the descriptive label provides a description of a topic that is more understandable to humans.

At block 404c, topic analysis module 206 determines respective topic distributions in the content items in the corpus of content. For instance, a topic distribution for a content item may be determined from the knowledge points contained in the content item. The topic distribution for a content item specifies the respective amount of each topic covered in the content item. For example, suppose there are ten topics, Topic A to Topic J. In this example, a topic distribution of (0.7, 0.2, 0.1, 0, 0, 0, 0, 0, 0, 0) over the ten topics for a content item indicates that 70% of the content item is regarding Topic A, 20% of the content item is regarding Topic B, 10% of the content item is regarding Topic C, and no part of the content item is regarding Topics D to J. In a more general sense, the topic distribution for a content item specifies the topics covered in the content item, including the respective amount or extent of each topic.

At block 406, topic analysis module 206 analyzes the specificity of the topics covered in a content item. For instance, topic analysis module 206 may perform such analysis for each content item in the corpus of content. Note that some topics are relatively more general, whereas other topics are more specific. For example, topics such as learning algorithms, reinforcement learning, machine learning, active learning, learning problem, online learning, algorithms for learning, supervised learning, unsupervised learning, and structured learning, to name a few examples, are more general relative to topics such as Gaussian process, Bayesian inference, approximate inference, Bayesian model, Gibbs sampling, exact inference, and Dirichlet process, to name a few examples, which are more specific. In some embodiments, topic analysis module 206 may determine the specificity (e.g., broad or specific) of a topic based on a hierarchy of the knowledge points in the topic. For instance, the hierarchy of knowledge points may be inferred from information in the content item, including the semantics of the knowledge points. In the hierarchy, more general (e.g., broad) knowledge points may be included in higher levels of the hierarchy, and more specific (e.g., narrow) knowledge points may be included in lower levels of the hierarchy. For example, a general knowledge point such as “machine learning” may be included in a first level of the hierarchy, and a specific knowledge point such as “supervised learning” and “unsupervised learning” associated with machine learning may be included in a lower level of the hierarchy that is a sub-level of the first level. Additional details regarding the categorizing of topics, including generating a hierarchy of knowledge points, are provided in U.S. Patent Application Publication No. 20170011642, entitled: “Extraction of Knowledge Points and Relations from Learning Materials,” filed Jul. 10, 2015, and now issued as U.S. Pat. No. 9,852,648, which is incorporated herein by reference in its entirety.

Referring again to process 300, at block 306, update module 208 updates information sources from which content is obtained to include sources that are determined to provide good (e.g., quality) content. For example, suppose an obtained content item is a published news article that includes an index page or other link to a web site, and the web site is not a web site that is presently included in the information sources. In this case, update module 208 may determine the quality of the website, for instance, based on information provided on or regarding the website, for example, a pagerank of the website, or the inclusion of the website, or an author of the website, in a list of authoritative sources. Based on the determined quality, update module 208 may update the information sources to include the website. As another example, suppose an obtained content item is a tweet that includes a link to a news article that is provided on a website that is presently included in the information sources. In a manner similar to the news article example above, update module 208 may update the information sources to include the website based on the quality of the website. In any such cases, update module 208 may discover new information sources from obtained content items and, responsive to a determination that a newly discovered information source is a good information source, update the information sources to include the newly discovered information source.

In some embodiments, the quality of a newly discovered website may be based on whether content provided on the newly discovered website is consistent with the topics covered in the content item that referenced the newly discovered website. For example, if the topics provided on the newly discovered website is consistent with the topics covered in the content item on which the new website is discovered, then the newly discovered website may be determined to be a website of good quality with respect to the topics covered in the corresponding content item. Otherwise, if the topics provided on the newly discovered website are inconsistent with the topics covered in the content item on which the new website is discovered, then the newly discovered website may be determined to be a website of poor (not good) quality with respect to the topics covered in the corresponding content item. In a more general sense, the degree of the quality of the newly discovered website may be determined from the degree of consistency between the topics provided on the newly discovered website and the topics covered in the content item on which the new web site is discovered.

At block 308, genre analysis module 210 identifies the types of content (content types), classifies the content items in the corpus of content as belonging to (or not belonging to) a particular genre of content, and extracts information from the content item based on the genre to which the content item belongs. In general, a content type is a type of medium for delivering the content. Examples of content types include portable document format (PDF) files, HTML pages, and video pages, to name three examples. Examples of genres include news, articles, programming codes, papers, slides, events, conferences, and lectures, to name a few examples. Note that a content type may be associated with a single genre or multiple genres. As will be further described below, the information extracted from a content item may be used to determine the quality of the content item.

In some embodiments, process 500 illustrated in FIG. 5 may correspond to block 308 of process 300. With reference to process 500, at block 502, genre analysis module 210 identifies the types of content in the corpus of content. In one example implementation, the type of content may be determined from a Uniform Resource Locator (URL) of a content item. For example, a file name extension “.html” in a URL of a content item indicates that the content item is an HTML file. Similarly, a file name extension “.pdf” in a URL of a content item indicates that the content item is a PDF file. In some cases, when the file name is not included in the URL for instance, the type of content item may be determined from the Hypertext Transfer Protocol (HTTP) content type header field. Additionally or alternatively, the type of content may be determined by an analysis of the content itself. For example, an analysis of formats or semantics of the content may be used to determine the type of content.

At block 504, genre analysis module 210 classifies the content items into genres. In some embodiments, the genre analysis module 210 may use the type of content determined at block 502 to classify the content items into genres. Example genres include papers, slides, programming codes, news, blogs, videos, books, lectures, jobs, and videos, to name a few examples. According to some embodiments, a content item may be classified as belonging to (or not belonging to) a particular genre based on one or more features, such as keyword features, URL features, and/or anchor text features, extracted from the content item. For instance, in the case of a content item being a webpage, feature extraction from the web page may include analyzing the visual structure and presentation of the web page to identify information blocks in the web page and extracting one or more features from the information blocks based on the visual position of each of the one or more features within a corresponding one of the information blocks. For example, a first set of features may be associated with (may be indicative of) of a first genre, a second set of features may be associated with a second genre, and so on.

In some embodiments, genre analysis module 210 may train a classification algorithm, such as a decision tree, a Support Vector Machine (SVM), naive Bayes, random forest, or other suitable classification algorithm, for use in classifying the content items into genres. For instance, genre analysis module 210 may utilize existing reading lists and/or newsletters from various knowledge domains a labeled training set. Such existing reading lists and newsletters from the different knowledge domains may contain similar sections, such as news, papers, jobs, events, programming codes, and blogs, to name a few examples. A suitable classification algorithm may be trained using the labeled training set. Genre analysis module 210 may then apply the trained classifier to the content items in the corpus of content to classify the content items into genres. Additional details regarding the genre classification, including training a classifier for use in classifying content items into genres, are provided in U.S. Patent Application Publication No. 20140188882, entitled: “Specific Online Resource Identification and Extraction,” filed Dec. 31, 2012, and now issued as U.S. Pat. No. 9,390,166, which is incorporated herein by reference in its entirety.

At block 506, genre analysis module 210 extracts information from or regarding the content items based on the respective genres of the content items. For instance, in the case of a content item being a paper, the extracted information may include the name of the author, the name of the organization to which the author belongs, the name of the organization posting or publishing the paper, the date of post or publication, and the number of times the paper is referenced by or in other papers or content items, to name a few examples. In the case of a content item being included in a blog or other social media post, the extracted information may also include the number of likes, the number of shares, the number of reads, and the number of retweets, to name a few examples. In any such cases, as will be further described below, information and metadata that may provide indication as to the quality (e.g., good, fair, poor, etc.) of a content item may be extracted and used to determine the quality of the content item. Such information may also be used to rank the content items, for example, according to quality.

Referring again to process 300, at block 310, reading list generator module 212 generates a reading list that is personalized for a specific user from the corpus of content obtained from the information sources. In a general sense, a generated reading list is personalized for a user in that the content items are selected and presented in a well-organized manner according to the preferences of the user. Note that reading list generator module 212 may also include in the reading list content items that may (or may not) match or fit the preferences of the user as will be apparent in light of this disclosure. Further note that reading list generator module 212 may generate multiple reading lists from the corpus of content.

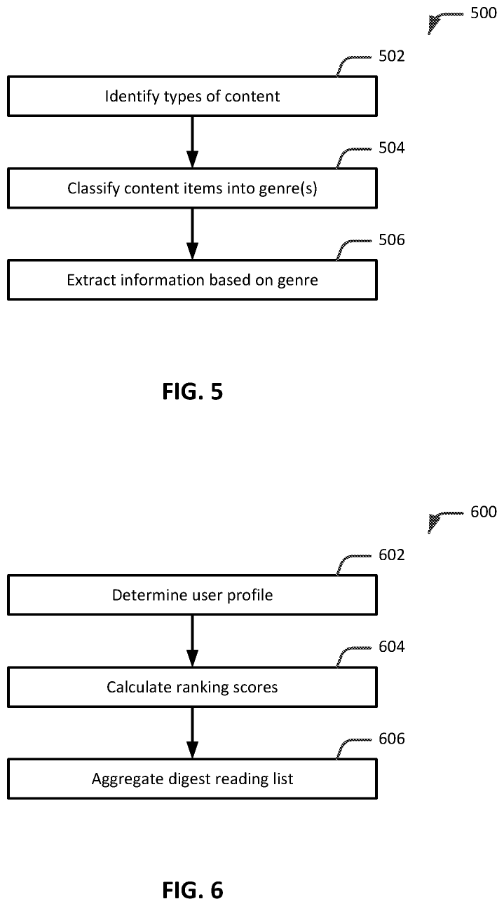

In some embodiments, process 600 illustrated in FIG. 6 may correspond to block 310 of process 300. With reference to process 600, at block 602, reading list generator module 212 determines a profile of a user for whom to generate a reading list. In an example use case and embodiment, a user may register with system 102 to periodically receive reading lists from system 102. As part of the registration, the user may provide general information, such as name and contact information, and reading list-specific information, such as a digest time window size, the topics of interest, a specificity level, number of content items to include in the reading list, and other preference information useful for generating a reading list personalized for the user. In some embodiments, the user may also specify a level or degree of interest for each topic of interest. For example, the level of interest may be specified using a scale from ‘1’ to ‘10’, where ‘1’ indicates a very low level of interest and ‘10’ indicates a very high level of interest. The specified level of interest may be used to determine various attributes of the generated reading list, such as a number of content items regarding a specific topic to include in the reading list, the positioning of the content items in the reading list, as well as other attributes of the reading list as will be apparent in light of this disclosure. For example, suppose the user specifies a low level of interest in Topic A and a high level of interest in Topic B. In this case, the reading list generated for the user may include a larger number of content items in Topic B as compared to the number of content items in Topic A. Additionally or alternatively, the section listing the content items in Topic B may appear higher (before) in the reading list than the content items in Topic A. In an example implementation, system 102 may provide one or more user interface windows and/or elements for use in providing such information. Such information may indicate the preferences of the user with regards to the specifics of the reading list generated for the user, and be maintained in a user profile associated with the user.

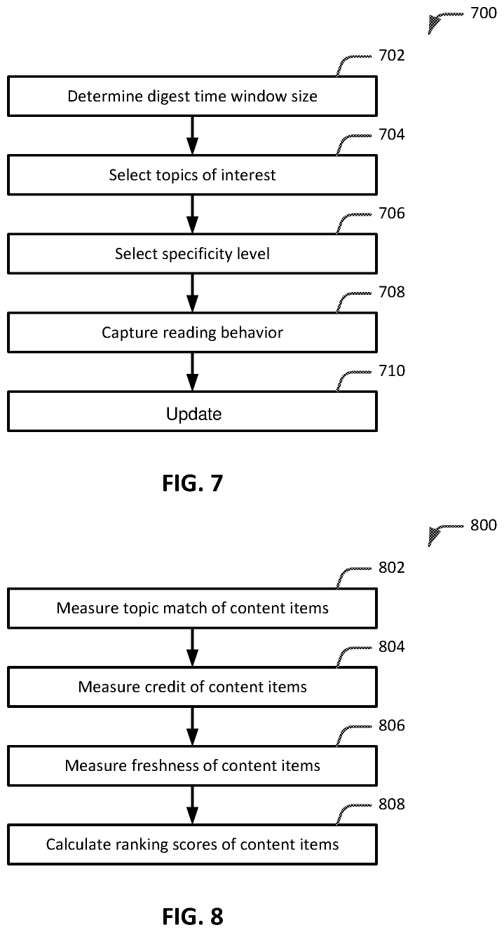

In some embodiments, process 700 illustrated in FIG. 7 may correspond to block 602 of process 600. With reference to process 700, at block 702, reading list generator module 212 determines a digest time window size. The digest time window size indicates a time period (e.g., one week, two weeks, one month, etc.) that defines the maximum age of the content items included in the reading list. For example, a digest time window size of one month indicates a preference to receive a reading list that includes content items that are not older than (e.g., content items published within) one month. Note that, in some cases, the generated reading list may also include content items that are outside the specified time period, as will be apparent in light of this disclosure.

At block 704, reading list generator module 212 selects the topics of interest. The topics of interest indicate or specify the topics that the user is interested in. The topics may be general or broad topics, such as science, politics, sports, leisure, travel, entertainment, and food and dining, to name a few examples. The topics may be specific or focused topics, such as artificial intelligence, US politics, US-China relations, US-EU trade, US financial markets, Asian financial markets, world cup, NFL, NBA, and PGA, to name a few examples. Note that, in some cases, the generated reading list may also include content items in topics other than those specified by the user, as will be apparent in light of this disclosure. In some embodiments, reading list generator module 212 may determine an interest level that indicates the level of interest of the user in each topic of interest.

At block 706, reading list generator module 212 selects the specificity level for the reading list. The specificity level indicates the degree or level of specificity of the content items to include in the reading list. In an example use case, a single specificity level may be specified for the reading list. In other cases, a specificity level may be specified for each of the different genres of content. Additionally or alternatively, a specificity level may be specified for each of the different topics of interest. In any such cases, the specificity level indicates the level (e.g., broad, intermediate, specific, etc.) of specificity (e.g., expertise) of the content items included in the reading list. For example, the broad specificity level may correspond to novice or non-expert, the intermediate specificity level may correspond to some-what of an expert, and the specific specificity level may correspond to an expert. In an example use case, the user may specify a preference to receive information appropriate for novices or beginners (broad specificity level). In this case, the reading list generated for the user includes content items that contain information that is broad and generally directed to novices in the topic or topics covered by the information. In another use case, the user may specify a preference to receive information appropriate for experts (specific specificity level). In this case, the reading list generated for the user includes content items that contain information that is specific and generally directed to experts in the topic or topics covered by the information. Note that the specificity specified by the user may (or may not) be indicative of the actual expertise of the user. Rather, the specified specificity level is indicative of the preference of the user with regards to the type of content items to include in the reading list generated for the user. Also note that, in some cases, the generated reading list may also include content items that are outside the specificity level, as will be apparent in light of this disclosure. Further note that, in come embodiments, the specificity level may be specified by the user.

In some embodiments, reading list generator module 212 may optionally monitor the behavior of a user, and update a user profile of the user based on the monitored behavior. In an example use case and embodiment, reading list generator module 212 may generate a reading list for a user based on user preference information from, for instance, a user profile. Subsequent to providing the generated reading list, reading list generator module 212 or other suitable component of system 102 may monitor the behavior of the user with respect to the generated reading list, and update the user profile associated with the user in accordance with the monitored user behavior. In this manner, subsequently generated reading lists may be based on user preferences that account for the monitored user behavior. For example, suppose the reading lists generated for a user include respective sections for four topics, Topic A, Topic B, Topic C, and Topic D, each with an equal number of content items as determined from the preferences of the user specified in the user profile. Also suppose that the monitored user behavior indicates that the user repeatedly reads content items in Topics A and B, but does not read content items in Topics C and D. In this case, the user profile may be updated to indicate a change or shift in the topics of interest of the user (e.g., Topics A and B may be assigned a higher level of interest as compared to Topics C and D, profile may be updated to indicate a larger number of content items to display in Topics A and B relative to the number of content items to display in Topics C and D, etc.). As another example, suppose the reading lists generated for a user includes additional content items in Topic E that is not specified as a topic of interest by the user, and the monitored user behavior indicates that the user regularly reads the content items in Topic E. In this case, the user profile may be updated to include Topic E as a topic of interest of the user. As still another example, suppose the reading lists generated for a user include content items in Topic A that are directed toward non-experts in Topic A, and the monitored user behavior indicates that the user has read a sufficient amounts of content items in Topic A. In this case, the user profile may be updated to indicate a higher level of specificity level for Topic A (e.g., specificity level for Topic A changed from novice to intermediate). In a more general sense, system 102 may monitor the reading list consumption behavior of the user and update the profile of the user to account for the monitored user preferences and behaviors.

Accordingly, at block 708, reading list generator module 212 may optionally monitor and capture the reading behavior of the user. The reading behavior may be indicative of how the user utilizes the reading list generated for the user. In some embodiments, different weights may be assigned to different behaviors. For example, the behavior of the user not reading, or skimming, a content item from the reading list may be assigned a first weight. The behavior of the user reading a content item from the reading list may be assigned a second weight higher than the first weight. The behavior of the user liking or bookmarking the content item be assigned a third weight higher than the second weight. The behavior of the user sharing the content item may be assigned a fourth weight higher than the third weight. At block 710, reading list generator module 212 may optionally update the information in the user profile based on (to account for) the monitored reading behavior of the user.

Referring again to process 600, at block 604, reading list generator module 212 calculates respective ranking scores for the content items in the corpus of content. For instance, a ranking score for a content item may be calculated based on one or more factors such as the preferences of the user for whom the reading list is being generated, the topic distribution in the content item, the specificity of the topics covered in the content item, information indicative of the quality of the content item, and/or other information related to the content item.

In some embodiments, process 800 illustrated in FIG. 8 may correspond to block 604 of process 600. With reference to process 800, at block 802, reading list generator module 212 measures a respective topic match for the content items in the corpus of content. A topic match of a content item is a measure of a degree of match between the topic distribution in the content item and the topics of interest of the user. Additionally or alternatively, the degree of match may also consider the specificity of the topics covered in the content item and the specificity level specified for the reading list. According to some embodiments, a measure of a topic match (TM) of a content item may be represented as:

TM=convex (linear) combination of TS and KS

where TS is a measure of similarity between the topic distribution in the content item and the topics of interest of the user, and KS is a measure of similarity between the knowledge points contained in the content item and the knowledge points associated with the topics of interest of the user. TS and KS may both be values between zero and one, where a value of one indicates a high degree of similarity and zero indicates a low degree of similarity. Thus, TM may be calculated, for example, as:

TM=0.6*TS+0.4*KS

At block 804, reading list generator module 212 measures respective credits of the content items in the corpus of content. In a general sense, a measure of credit of a content item may be similar to a measure of quality of the content item. According to some embodiments, a measure of credit (CR) of a content item may be based on one or more factors such as a credit measurement of the author of the content item, a credit measurement associated with an account, such as a social media account, through which the content item is posted, a credit measurement associated with an information source from which the content item is obtained, and/or various measures of quality of the content item (e.g., a number of reposts of the content item, a number of likes for the content item, a number of views of the content item, a number of times the content item is bookmarked, etc.). Additional details regarding measuring credit of a content item are provided in U.S. Patent Application Publication No. 20180046628, entitled: “Ranking Social Media Content,” filed Aug. 12, 2016, which is incorporated herein by reference in its entirety.

At block 806, reading list generator module 212 measures respective freshness of the content items in the corpus of content. The freshness of a content item is a measure of the age of the content item. In a general sense, content items that are fresher may be considered better than content items that are less fresh. For example, an article that is recently published or posted may be considered better than an earlier published or posted article. According to some embodiments, freshness (FR) of a content item may be calculated according to the following equation: FR=exp(−γ*T), wherein γ is a constant used to adjust impact of age. Additional details regarding the measuring of content freshness are provided in above-referenced U.S. Patent Application Publication No. 20180046628, entitled: “Ranking Social Media Content,” filed Aug. 12, 2016.

At block 808, reading list generator module 212 calculates respective ranking scores for the content items in the corpus of content. A ranking score of a content item may be an indication of the quality of the content item with respect to the user preferences. According to some embodiments, a ranking score (RS) of a content item may be calculated as a convex (linear) combination of the TM, CR, and FR scores (or measures) of the content item. Additional details regarding the calculation of ranking scores are provided in above-referenced U.S. Application Publication No. 20180046628, entitled: “Ranking Social Media Content,” filed Aug. 12, 2016.

Referring again to process 600, at block 606, reading list generator module 212 aggregates a reading list from the content items in the corpus of content. The aggregated reading list is personalized for the user in that the reading list is generated in accordance with some or all of the user preferences.

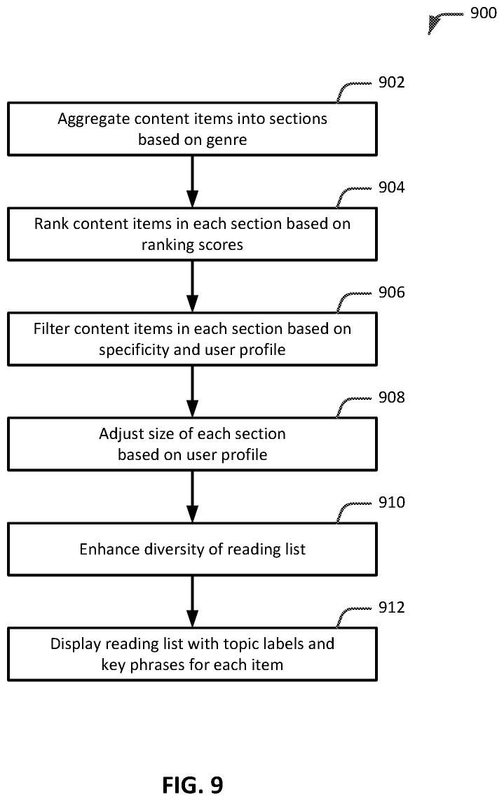

In some embodiments, process 900 illustrated in FIG. 9 may correspond to block 606 of process 600. With reference to process 900, at block 902, reading list generator module 212 aggregates the content items into sections based on the genres associated with the content items. For example, content items classified as belonging to a first genre are aggregated into a first section in a reading list, content items classified as belonging to a second genre are aggregated into a second section in the reading list, content items classified as belonging to a third genre are aggregated into a third section in the reading list, and so on. As such, the reading list includes one or more sections, where each section corresponds to a specific genre and includes the content items classified as belonging to the specific genre.

At block 904, reading list generator module 212 ranks the content items in each section of the reading list according to the respective ranking scores calculated for the content items. For example, content items having higher ranking scores may be listed higher (or before) in a section than content items having lower ranking scores.

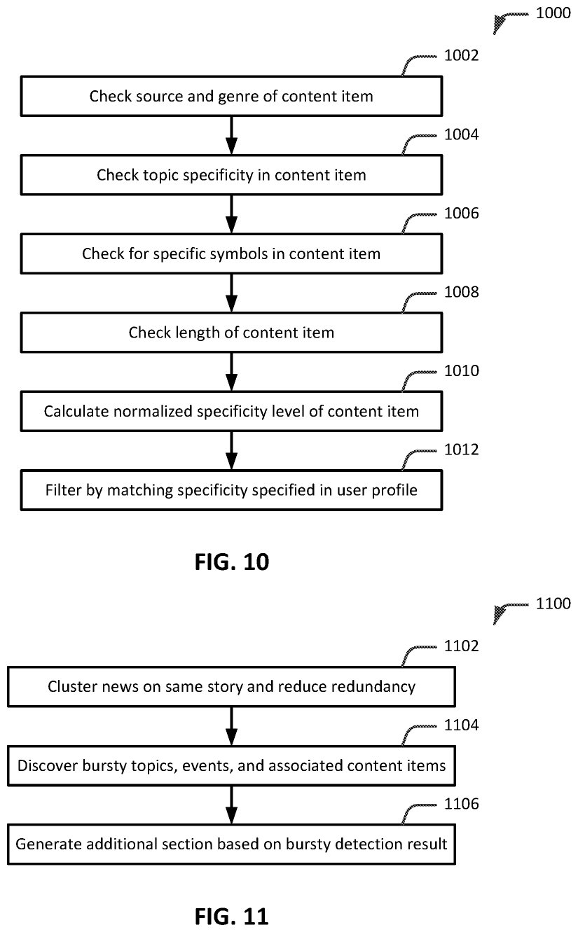

At block 906, reading list generator module 212 filters the content items in each section based on the specificity of each content item and the specificity level (or specificity levels) specified for the reading list. In some embodiments, process 1000 illustrated in FIG. 10 may correspond to block 906 of process 900. With reference to process 1000, at block 1002, reading list generator module 212 checks the information source and genre of each content item. The information source, including the type of information source, and genre may be indicative of different expertise levels for specific knowledge domains. For example, a content item from a main stream information source that generally provides content for the public generally has a lower specificity (expertise) level than a content item from an information source that provides content directed to experts in a knowledge domain. As another example, content items belonging to certain genres, such as programming codes and papers, generally have higher specificity (expertise) levels in technology-directed domains than content items belonging to other genres in the same domain. In a more general sense, the information regarding the source of the content item and/or the genre to which the content item belongs may be used as indicators of the specificity level of the content item. Accordingly, reading list generator module 212 may assign a first specificity score to the content item based on the information source and genre associated with the content item.

At block 1004, reading list generator module 212 checks the specificity of the topics covered in each content item. In general, popular content for consumption by the public is generally less specific (e.g., the information in such content items that are for public consumption is of less specificity) than content that cover highly specific concepts in specific knowledge domains, such as high technology. In accordance with some embodiments, reading list generator module 212 may measure a specificity level of a content item based on an overall hierarchy of knowledge points in the topics covered in the content item. Reading list generator module 212 may assign a second specificity score to the content item based on the specificity of the topics covered in the content item.

At block 1006, reading list generator module 212 checks each content item for inclusion of specific symbols. The inclusion or presence of specific symbols, such as mathematical equations, engineering drawings, and programming language and codes, in a content item may be indicative of the specificity level of the content item. For example, content items that contains such specific symbol or symbols may be of higher specificity than content items that do not include such specific symbols. In some cases, the amount or number of specific symbols included in a content item may also factor in the degree or level of specificity of the content item. In other cases, corresponding weights may be assigned to the various types of specific symbols. For example, mathematical equations may be assigned a higher weight than engineering drawings. Reading list generator module 212 may assign a third specificity score to the content item based on the inclusion or presence of such specific symbols in the content item.

At block 1008, reading list generator module 212 checks the length of each content item. The length of a content item may be based on factors such as the number of alpha-numeric characters, the number of words, the number of lines, or any combination of thereof. For example, a content item that is longer may be of higher specificity than a shorter content item. Reading list generator module 212 may assign a fourth specificity score to the content item based on the length of the content item.

At block 1010, reading list generator module 212 calculates a normalized specificity level of each content item. According to some embodiments, the normalized specificity level of a content item may be calculated as an average of one or more of the first specificity score, second specificity score, third specificity score, and/or fourth specificity score described previously and assigned to the content item. The calculated specificity levels of the content items may be normalized, for example, into a range from 0 to 1.

At block 1012, reading list generator module 212 filters the content items in each section of the reading list based on the specificity level specified for the reading list. As described previously, a specificity level may be specified for the reading list and, in some cases, a specificity level may be specified for each section (e.g., topic, genre, etc.) in the reading list. For instance, reading list generator module 212 may filter the content items in the reading list (or a section of the reading list) by removing from the reading list (or the section of the reading list) the content items whose specificity level fails to match the specificity level specified for the reading list (or the section of the reading list).

Referring again to process 900, at block 908, reading list generator module 212 adjusts the size of each section of the reading list based on the profile of the user. For instance, in some embodiments, reading list generator module 212 may adjust the size of the sections in the reading list based on the expertise of the user (expertise level of the user). For example, for an expert user (e.g., user having a high expertise level), the size of sections, such as sections for technical papers and programming codes, that include content items that are of specific specificity in a domain (e.g., content items generally directed to experts) may be adjusted to include a larger number of content items as compared to the size of sections that include content items that are of broad specificity. Conversely, for a non-expert or novice user (e.g., user having a relatively low expertise level), the size of sections, such as sections for news and events, that include content items that are of broad specificity in a domain (e.g., content items generally directed to non-experts) may be adjusted to include a larger number of content items as compared to the size of sections that include content items that are of specific specificity. According to some embodiments, reading list generator module 212 may adjust the size of the sections in the reading list based on a section size specified by the user. For example, the user may specify a preference for each section in the reading list to include a specific number of content items, such as five, ten, or other appropriate number of content items. In this case, reading list generator module 212 may adjust the size of each section of the reading list to include at most the number of content items specified by the user. Note that the user may specify different sizes for different sections in the reading list. Further note that, in some embodiments, the user may specify the size of certain sections of the reading list while the sizes of other sections in the reading list may be dynamically adjusted according to the expertise level of the user.

At block 910, reading list generator module 212 may enhance the diversity of the reading list. Here, reading list generator module 212 may enhance the diversity of the reading list by including in the reading content items that are not directly in the topics of interest of the user. While not directly in the topics of interest of the user, such content items may be in topics that the user may be interested in. In some embodiments, process 1100 illustrated in FIG. 11 may correspond to block 910 of process 900. With reference to process 1100, at block 1102, reading list generator module 212 identifies and clusters content items that include news on or regarding the same story to reduce or in some cases eliminate redundancy. For example, an item of breaking news, such as a new product release, breakthrough on research, or other hot news story, may occur that is reported by multiple news sources. Although the news story may be outside the topic of interest of the user, reading list generator module 212 may determine that such a news story may be of interest to the user. Accordingly, reading list generator module 212 may cluster the multiple content items on the same item of news, identify a representative one of the multiple content items, and include the representative content item in the reading list generated for the user. Note that such content items may be included in a separate section in the reading list. Further note that the separate section may be appropriately labeled (e.g., Breaking News) to identify the category of content items included in the section.

At block 1104, reading list generator module 212 discovers bursty topics, events, and/or content items. The term “bursty” may refer to occurrence at intervals in short sudden intervals or spurts. Hence, “bursty topic” may refer to a topic that is occurring or experiencing a short, sudden period of activity. Similarly, “bursty event” may refer to an event that is occurring or experiencing a short, sudden period of activity. For example, a bursty event in sports may be the Super Bowl, and content items associated with this bursty event are content items covering the Super Bowl. Similarly, a bursty topic in politics may be an upcoming election, and content items associated with this bursty topic are content items covering the election. In a general sense, such content items associated with bursty topics and/or events may be of interest to a user. Additional details regarding detection of bursty topics are provided in U.S. application Ser. No. 15/710,684, entitled: “Bursty Detection for Message Streams,” filed Sep. 20, 2017, which is incorporated herein by reference in its entirety.

At block 1106, reading list generator module 212 includes the content items associated with the discovered bursty topics and/or events in the reading list to enhance the diversity of the reading list. Note that such content items may be included in a separate section in the reading list. Further note that the separate section may be appropriately labeled (e.g., Bursty Topics and Events) to identify the category of content items included in the section. In some embodiments, reading list generator module 212 may rank and/or filter the content items associated with the discovered bursty topics and/or events. For instance, such content items may be ranked and/or filtered based on factors such as freshness, size, relatedness to the topics of interest of the user, quality of the information source from which the content item is obtained, and other suitable factors as will be apparent in light of this disclosure.

Referring again to process 900, at block 912, reading list generator module 212 displays the aggregated reading list. For instance, reading list generator module 212 may cause the display of the aggregated reading list on a display device of the computing device being used by the user to interact with system 102. The reading list may include the topic labels. For instance, the topic labels may be included in corresponding sections of the reading list. The reading list may include one or more key phrases for each content item in the reading list. For instance, the key phrases for a content item may be included in a digest of the content item.

FIG. 12 is a block diagram illustrating selected components of example computing system 1200 that may be used to perform any of the techniques as variously described in the present disclosure, in accordance with at least some embodiments of the present disclosure. In some embodiments, computing system 1200 may be configured to implement or direct one or more operations associated with some or all of the engines, components and/or modules associated with system 102 of FIG. 1. For example, information fetch module 204, topic analysis module 206, update module 208, genre analysis module 210, and reading list generator module 212, or any combination of these may be implemented in and/or using computing system 1200. In one example case, for instance, each of information fetch module 204, topic analysis module 206, update module 208, genre analysis module 210, and reading list generator module 212 is loaded in memory 1204 and executable by a processor 1202, and user profiles store 214 is included in data storage 1206. Computing system 1200 may be any computer system, such as a workstation, desktop computer, server, laptop, handheld computer, tablet computer (e.g., the iPad® tablet computer), mobile computing or communication device (e.g., the iPhone® mobile communication device, the Android™ mobile communication device, and the like), or other form of computing or telecommunications device that is capable of communication and that has sufficient processor power and memory capacity to perform the operations described in this disclosure. A distributed computational system may be provided that includes a multiple of such computing devices. As depicted, computing system 1200 may include processor 1202, memory 1204, and data storage 1206. Processor 1202, memory 1204, and data storage 1206 may be communicatively coupled.

In general, processor 1202 may include any suitable special-purpose or general-purpose computer, computing entity, or computing or processing device including various computer hardware, firmware, or software modules, and may be configured to execute instructions, such as program instructions, stored on any applicable computer-readable storage media. For example, processor 1202 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 12, processor 1202 may include any number of processors and/or processor cores configured to, individually or collectively, perform or direct performance of any number of operations described in the present disclosure. Additionally, one or more of the processors may be present on one or more different electronic devices, such as different servers.

In some embodiments, processor 1202 may be configured to interpret and/or execute program instructions and/or process data stored in memory 1204, data storage 1206, or memory 1204 and data storage 1206. In some embodiments, processor 1202 may fetch program instructions from data storage 1206 and load the program instructions in memory 1204. After the program instructions are loaded into memory 1204, processor 1202 may execute the program instructions.

For example, in some embodiments, any one or more of the engines, components and/or modules of system 102 may be included in data storage 1206 as program instructions. Processor 1202 may fetch some or all of the program instructions from data storage 1206 and may load the fetched program instructions in memory 1204. Subsequent to loading the program instructions into memory 1204, processor 1202 may execute the program instructions such that the computing system may implement the operations as directed by the instructions.

In some embodiments, virtualization may be employed in computing device 1200 so that infrastructure and resources in computing device 1200 may be shared dynamically. For example, a virtual machine may be provided to handle a process running on multiple processors so that the process appears to be using only one computing resource rather than multiple computing resources. Multiple virtual machines may also be used with one processor.

Memory 1204 and data storage 1206 may include computer-readable storage media for carrying or having computer-executable instructions or data structures stored thereon. Such computer-readable storage media may include any available media that may be accessed by a general-purpose or special-purpose computer, such as processor 1202. By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other non-transitory storage medium which may be used to carry or store particular program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause processor 1202 to perform a certain operation or group of operations.

Modifications, additions, or omissions may be made to computing system 1200 without departing from the scope of the present disclosure. For example, in some embodiments, computing system 1200 may include any number of other components that may not be explicitly illustrated or described herein.

As indicated above, the embodiments described in the present disclosure may include the use of a special purpose or a general-purpose computer (e.g., processor 1202 of FIG. 12) including various computer hardware or software modules, as discussed in greater detail herein. As will be appreciated, once a general-purpose computer is programmed or otherwise configured to carry out functionality according to an embodiment of the present disclosure, that general purpose computer becomes a special purpose computer. Further, as indicated above, embodiments described in the present disclosure may be implemented using computer-readable media (e.g., memory 1204 of FIG. 12) for carrying or having computer-executable instructions or data structures stored thereon.

Numerous example variations and configurations will be apparent in light of this disclosure. According to some examples, computer-implemented methods to generate a reading list are described. An example computer-implemented method may include: generating a corpus of content, the corpus of content comprising a plurality of content items; calculating a ranking score of each content item in the corpus of content items, the ranking score of a content item being based on one or more of a topic match of the content item, a credit of the content item, and a freshness of the content item; aggregating each content item of the plurality of content items into a section of a plurality of sections in a reading list tailored for a user; ranking content items in each section of the plurality of sections based on respective ranking scores of the content items; and causing display of the reading list according to ranking of the content items.

In some examples, the topic match of a content item is a measure of a degree of match between a topic distribution in the content item and topics of interest of the user. In other examples, the topic the topic distribution in the content item is determined using machine learning. In still other examples, the plurality of content items is obtained from a plurality of information sources on the Web. In yet other examples, each content item of the plurality of content items is aggregated into a section according to a genre associated with each content item. In further examples, the genre associated with each content item is determined using a trained classifier. In still further examples, the ranking score of a content item is a convex combination of a topic match of the content item, a credit of the content item, and a freshness of the content item. In yet further examples, the method may also include filtering content items in each section of the plurality of sections based on a specify of each content item and a specificity level specified for the reading list. In some examples, the method may also include filtering content items in each section of the plurality of sections based on a specify of each content item and a specificity level specified for the section of the reading list. In other examples, the method may also include adjusting a size of each section in the reading list based on a preference of the user. In still other examples, the method may include enhancing a diversity of the reading list.

According to some examples, computer program products including one or more non-transitory machine-readable mediums encoded with instructions that when executed by one or more processors cause a process to be carried out to generate a reading list are described. An example process may include: generating a corpus of content, the corpus of content comprising a plurality of content items; calculating a ranking score of each content item in the corpus of content items, the ranking score of a content item being based on one or more of a topic match of the content item, a credit of the content item, and a freshness of the content item; aggregating each content item of the plurality of content items into a section of a plurality of sections in a reading list tailored for a user; ranking content items in each section of the plurality of sections based on respective ranking scores of the content items; and causing display of the reading list.

In some examples, the topic match of a content item is a measure of a degree of match between a topic distribution in the content item and topics of interest of the user. In other examples, each content item of the plurality of content items is aggregated into a section according to a genre associated with each content item. In still other examples, the genre associated with a content item is determined based on one or more features of the content item. In yet other examples, the ranking score of a content item is a convex combination of a topic match of the content item, a credit of the content item, and a freshness of the content item.

According to other examples, systems to generate a reading list are described. An example system may include: one or more non-transitory machine-readable mediums configured to store instructions; and one or more processors configured to execute the instructions stored on the one or more non-transitory machine-readable mediums. Execution of the instructions by the one or more processors may cause the one or more processors to: generate a corpus of content, the corpus of content comprising a plurality of content items, calculate a ranking score of each content item in the corpus of content items, the ranking score of a content item being a convex combination of a topic match of the content item, a credit of the content item, and a freshness of the content item, aggregate each content item of the plurality of content items into a section of a plurality of sections in a reading list tailored for a user, rank content items in each section of the plurality of sections based on respective ranking scores of the content items, and cause display of the reading list.

In some examples, execution of the instructions causes the one or more processors to filter content items in each section of the plurality of sections based on a specify of each content item and a specificity level specified for the reading list. In other examples, execution of the instructions causes the one or more processors to adjust a size of each section in the reading list based on a preference of the user. In still other examples, execution of the instructions causes the one or more processors to enhance a diversity of the reading list.

As used in the present disclosure, the terms “engine” or “module” or “component” may refer to specific hardware implementations configured to perform the actions of the engine or module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations, firmware implements, or any combination thereof are also possible and contemplated. In this description, a “computing entity” may be any computing system as previously described in the present disclosure, or any module or combination of modulates executing on a computing system.

Terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, such recitation should be interpreted to mean at least the recited number (e.g., the bare recitation of “two widgets,” without other modifiers, means at least two widgets, or two or more widgets). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure. Accordingly, it is intended that the scope of the present disclosure be limited not by this detailed description, but rather by the claims appended hereto.

What is claimed is:

1. A computer-implemented method to generate a reading list, the method comprising:
generating a corpus of content, the corpus of content comprising a plurality of content items;
calculating a ranking score of each content item in the corpus of content items, the ranking score of a content item being based on one or more of a topic match of the content item, a credit of the content item, and a freshness of the content item;
aggregating each content item of the plurality of content items into a section of a plurality of sections in a reading list tailored for a user;
ranking content items in each section of the plurality of sections based on respective ranking scores of the content items; and
causing display of the reading list according to the ranked content items.

2. The method of claim 1, wherein the topic match of a content item is a measure of a degree of match between a topic distribution in the content item and topics of interest of the user.

3. The method of claim 2, wherein the topic distribution in the content item is determined using machine learning.

4. The method of claim 1, wherein the plurality of content items is obtained from a plurality of information sources connected to a network.

5. The method of claim 1, wherein each content item of the plurality of content items is aggregated into a section according to a genre associated with each content item.

6. The method of claim 5, wherein the genre associated with each content item is determined using a trained classifier.

7. The method of claim 1, wherein the ranking score of a content item is a convex combination of a topic match of the content item, the credit of the content item, and the freshness of the content item.

8. The method of claim 1, further comprising filtering content items in each section of the plurality of sections based on a specificity of each content item and a specificity level specified for the reading list.

9. The method of claim 1, further comprising filtering content items in each section of the plurality of sections based on a specificity of each content item and a specificity level specified for the section of the reading list.

10. The method of claim 1, further comprising adjusting a size of each section in the reading list based on a preference of the user.

11. The method of claim 1, further comprising enhancing a diversity of the reading list.

12. A computer program product including one or more non-transitory machine-readable mediums encoded with instruction that when executed by one or more processors cause a process to be executed to generate a reading list, the process comprising:
generating a corpus of content, the corpus of content comprising a plurality of content items;
calculating a ranking score of each content item in the corpus of content items, the ranking score of a content item being based on one or more of a topic match of the content item, a credit of the content item, and a freshness of the content item;
aggregating each content item of the plurality of content items into a section of a plurality of sections in a reading list tailored for a user;
ranking content items in each section of the plurality of sections based on respective ranking scores of the content items; and
causing display of the reading list according to the ranked content items.

13. The computer program product of claim 12, wherein the topic match of a content item is a measure of a degree of match between a topic distribution in the content item and topics of interest of the user.

14. The computer program product of claim 12, wherein each content item of the plurality of content items is aggregated into a section according to a genre associated with each content item.

15. The computer program product of claim 14, wherein the genre associated with a content item is determined based on one or more features of the content item.

16. The computer program product of claim 12, wherein the ranking score of a content item is a convex combination of a topic match of the content item, the credit of the content item, and the freshness of the content item.

17. A system to generate a reading list, the system comprising:
one or more non-transitory machine-readable mediums configured to store instructions; and
one or more processors configured to execute the instructions stored on the one or more non-transitory machine-readable mediums, wherein execution of the instructions causes the one or more processors to
generate a corpus of content, the corpus of content comprising a plurality of content items,
calculate a ranking score of each content item in the corpus of content items, the ranking score of a content item being a convex combination of a topic match of the content item, a credit of the content item, and a freshness of the content item,
aggregate each content item of the plurality of content items into a section of a plurality of sections in a reading list tailored for a user,
rank content items in each section of the plurality of sections based on respective ranking scores of the content items, and
cause display of the reading list according to the ranked content items.

18. The system of claim 17, wherein execution of the instructions causes the one or more processors to filter content items in each section of the plurality of sections based on a specificity of each content item and a specificity level specified for the reading list.

19. The system of claim 17, wherein execution of the instructions causes the one or more processors to adjust a size of each section in the reading list based on a preference of the user.

20. The system of claim 17, wherein execution of the instructions causes the one or more processors to enhance a diversity of the reading list.
